(19) United States
(12) Patent Application Publication
(10) Pub. No.: US 2006/0054692 A1
(43) Pub. Date: Mar. 16, 2006

(54) Wireless inventory management system and method

(76) Inventor: David Dickey, Austin, TX (US)

Correspondence Address: CARSTENS & CAHOON, LLP, P O BOX 802334, DALLAS, TX, 75380, US

(21) Appl. No.: 11/199,729

(22) Filed: Aug. 9, 2005

Related U.S. Application Data
(60) Provisional application No. 60/600,032, filed on Aug. 9, 2004.

(51) Int. Cl. G06Q 30/00

(52) U.S. Cl. 235/385

(57) ABSTRACT

A wireless inventory management system (WIA) and method to provide access and update inventory data in real-time from anywhere and anytime. WIA allows a user to query, pick, pack and receive orders from a wireless device, and allows a user to view the ID, SKU, name, description, Bin ID, list price and other product information from a user's accounting system. Inventory data is input through a simple wireless keyboard or barcode scanning device. The system and method provides a user with instant access to data necessary to make inventory management decisions with accurate and timely information. The WIA system reduces “out-of-stock” instances. The WIA system integrates with a user's accounting system.

### CROSS REFERENCE TO RELATED APPLICATIONS

The present application claims priority to the provisional application having serial number 60/600,032 filed on Aug. 9, 2004. The content of the cross referenced application is hereby incorporated herein by reference.

### BACKGROUND

1. Technical Field

This invention relates to a method for managing inventory in a computer system and specifically to an improved method utilizing a relational database and a wireless handheld device operating a software application which can scan both human and computer readable information on product labels.

2. Description of Related Art

The present invention generally relates to managing and accounting for inventory. Historically, this has involved making entries manually between various computer software applications. There often is a time delay of hours or even days before accounting systems reflected changes in actual inventory, and such accounting systems rarely matched actual, real-time inventory.

Accordingly, a need exists for a process and method which allows users to more quickly and easily assemble lists of items and more easily organize them into carts or other containers without switching between applications. Further, a need exists for an application to capture and persist such information in an electronic relational database, and to connect this information to an accounting system wherein real-time changes to inventory may be updated and monitored.

Other desirable features and characteristics of the present invention will become apparent from the subsequent detailed description and the appended claims, taken in conjunction with the accompanying drawings and the foregoing technical field and background.

### SUMMARY OF THE INVENTION

The present invention is an improved system and method for managing inventory and order information. A wireless inventory management (WIA) system may be fully integrated with MICROSOFT GREAT PLAINS, MICROSOFT SOLOMON, and BEST accounting software applications. A user is able to access and update inventory data in real-time from anywhere and anytime through a wireless solution. WIA allows a user to query, pick, pack and receive orders from a wireless device running WINDOWS operating system or WINDOWS CE operating system. WIA allows a user to view the ID, SKU, name, description, Bin ID, list price and other information from a user's accounting system. Inventory data is input through a simple wireless keyboard or barcode scanning device. The system and method provides a user with instant access to the data necessary to make inventory management decisions with accurate and timely information.

The WIA system provides users, employees, partners and suppliers with instant access to the vital inventory information to make faster, more accurate decisions. The WIA system tracks and updates inventory information in real-time for a more accurate ordering and fulfillment process, greatly reducing “out-of-stock” instances. The WIA system integrates with a user's accounting system to streamline processes and create a more efficient operating environment that saves valuable time and money. The WIA system provides users with more accurate information by updating inventory information in real-time. The WIA system eliminates “out-of-stock” instances and maintains more accurate inventory levels. The WIA system greatly reduces the cost of deploying multiple client devices in the field by allowing access to inventory information from any hand-held device.

Users input UPC code information via a keypad or a scanner to retrieve critical information including product SKU, product name, product description, bin ID and product ID from an accounting system.

When a user logs into an accounting system working with, and forming part of, the present invention, all scheduled counts for a specific database are displayed. The user selects the site and bins they wish to count. The bin count is instantly updated within the accounting system. The invention allows the user to pick items from specific bins and deduct the count from the accounting system when fulfilling an order. This mechanism ensures the accounting system always reflects true inventory.

Once an order is packed, information is sent to the accounting system to confirm it matches the original order. If the packing order is correct, a packing list is printed with the details for each item to be shipped. Users can access purchase orders and see a detailed list of items in an order. The user then simply enters the items received. Once complete, the WIA system enters a confirmation receipt in the accounting system. The WIA system is extendible and expandable.

The invention accordingly comprises the features described more fully below, and the scope of the invention will be indicated in the claims. Further objects of the present invention will become apparent in the following detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1.1 through FIG. 12.6 are software forms providing a user interface to the software application according to one embodiment of the present invention.

### DETAILED DESCRIPTION

While the invention is described below with respect to a preferred embodiment, other embodiments are possible. The concepts disclosed herein apply equally to other similar methods for receiving, picking, packing and tracking orders of products. Further, the concepts also apply to tracking, counting and transferring inventory information. Finally, the invention applies to order and inventory tracking systems and methods used in conjunction with a wireless scanning device.

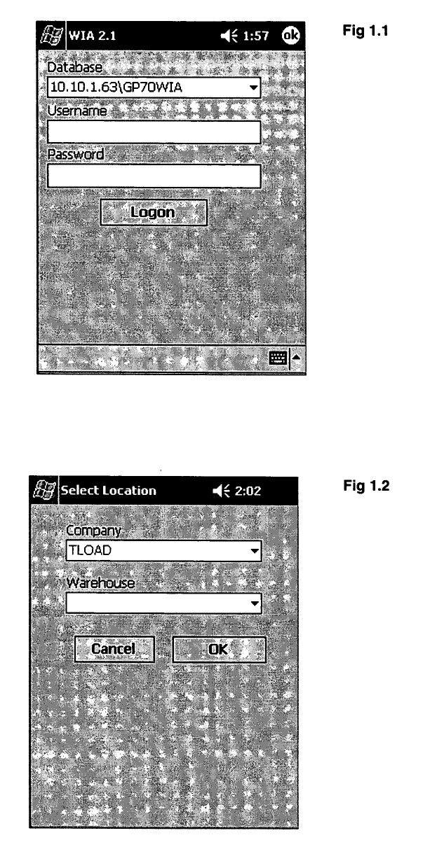

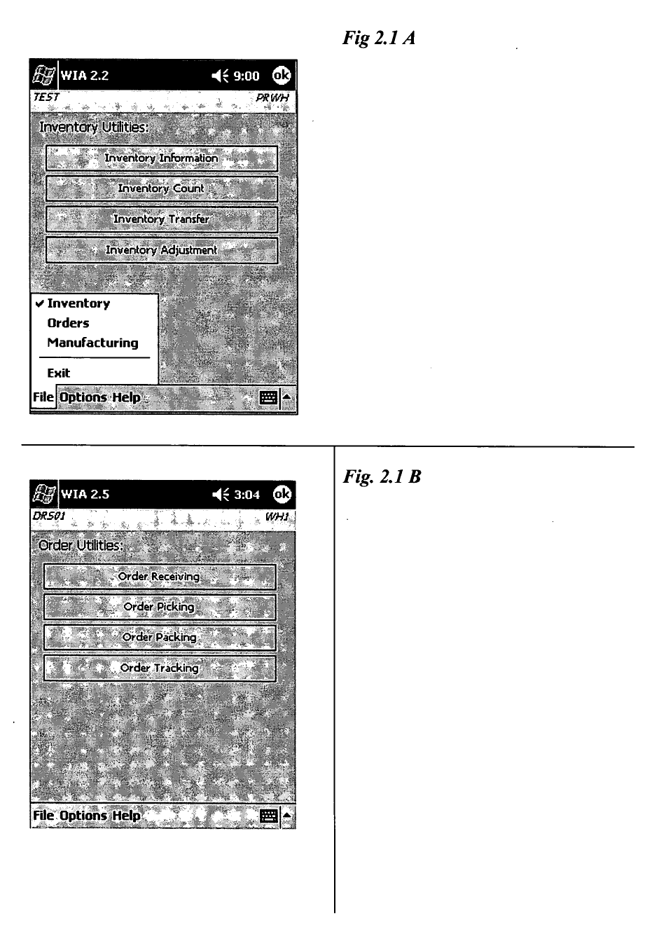

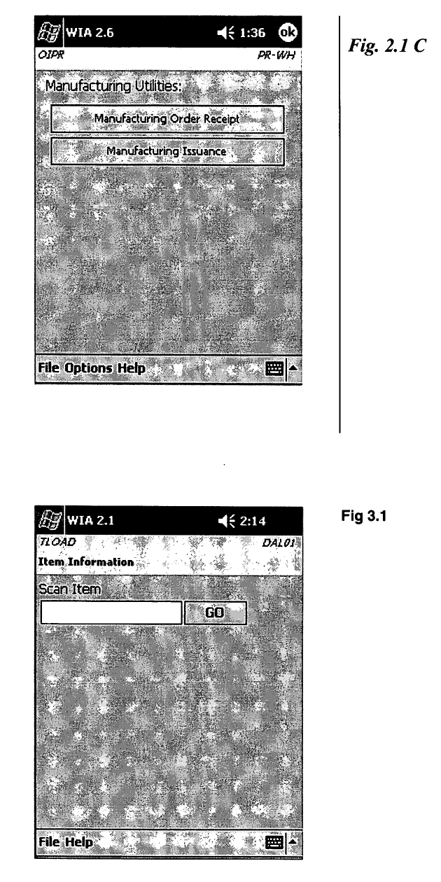

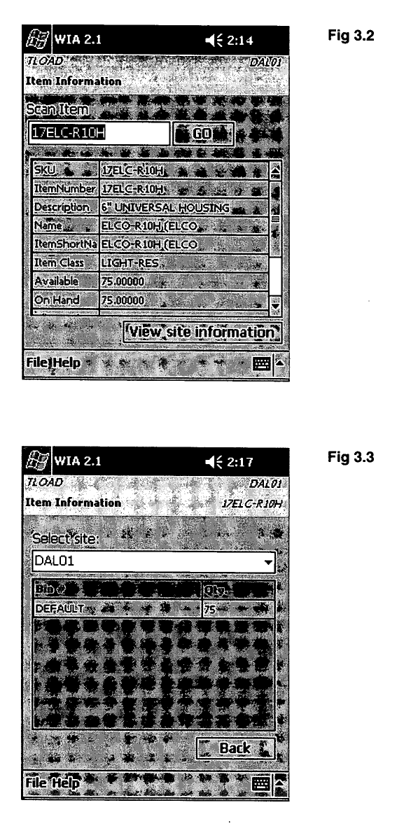

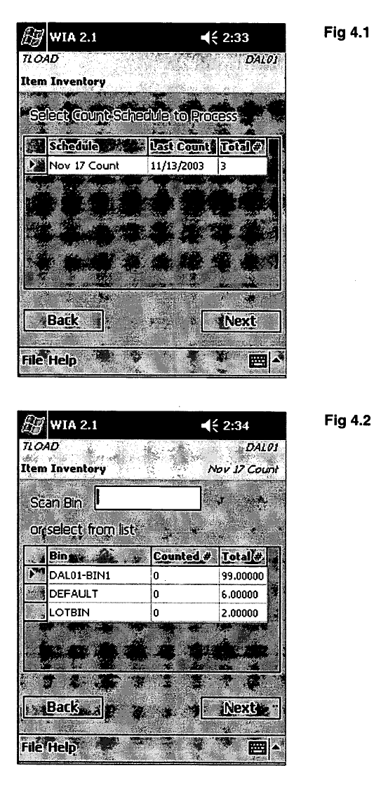

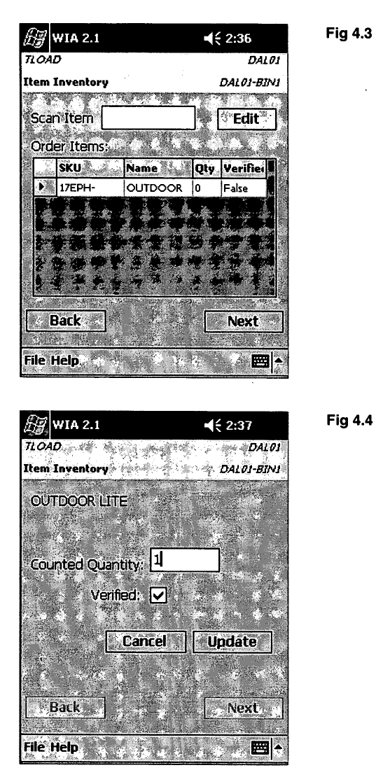

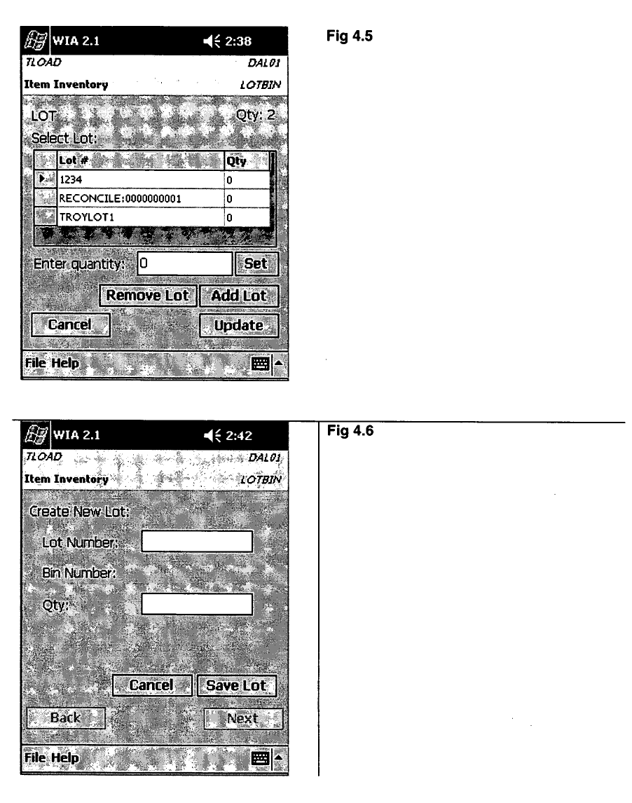

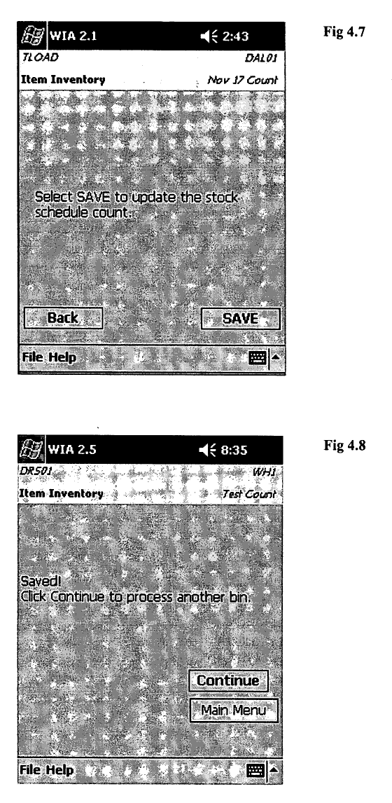

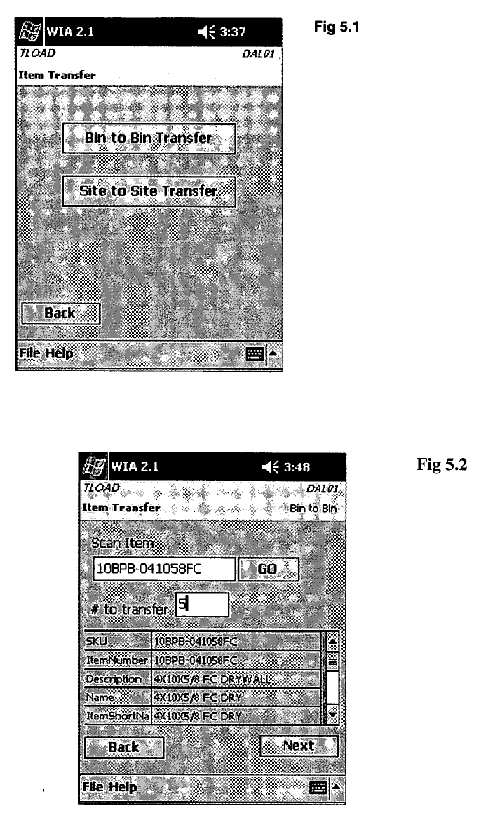

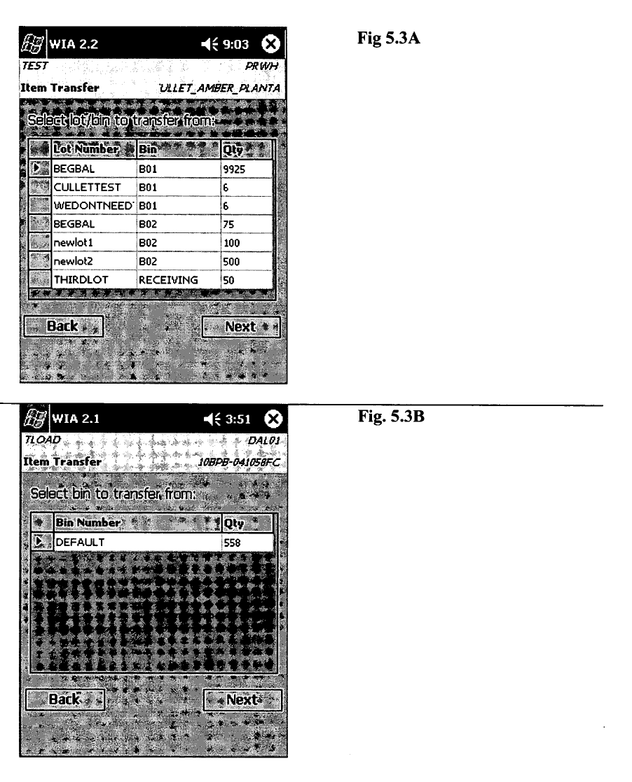

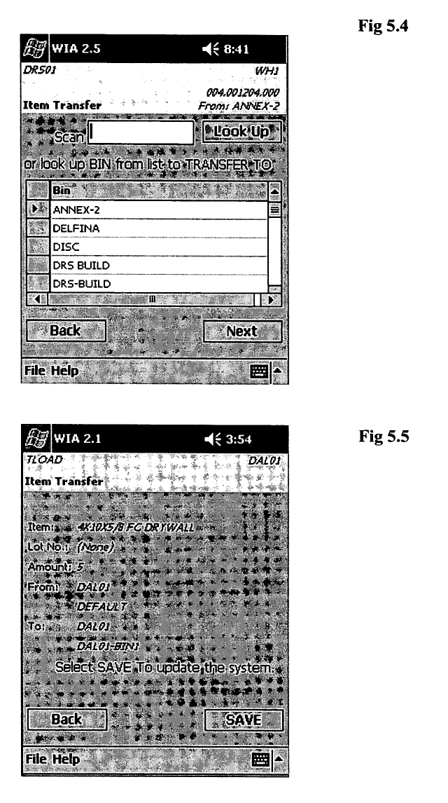

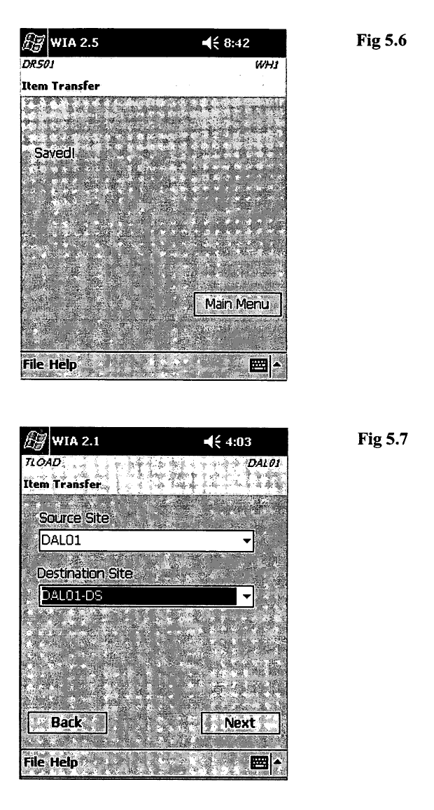

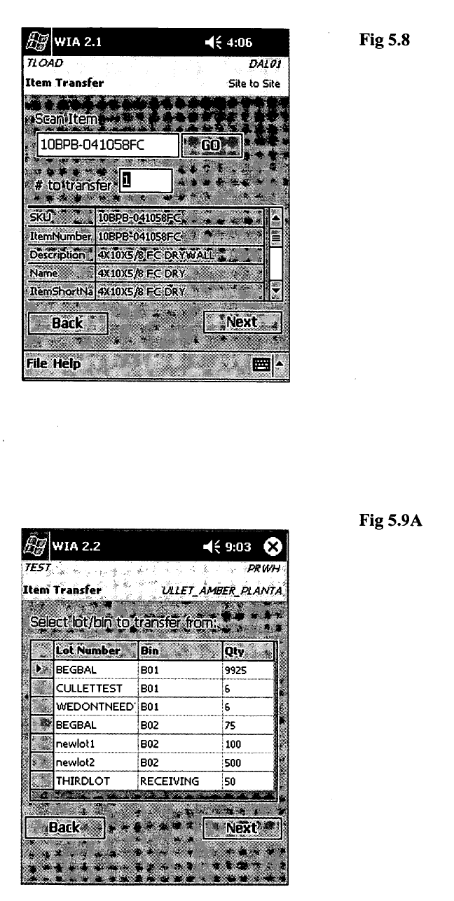

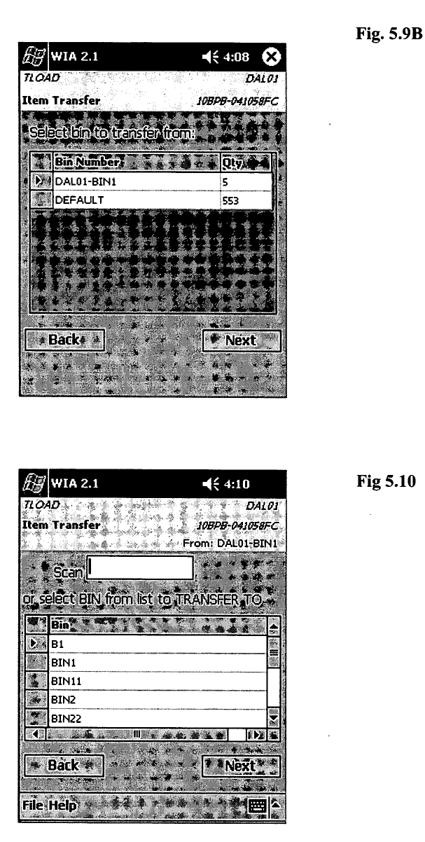

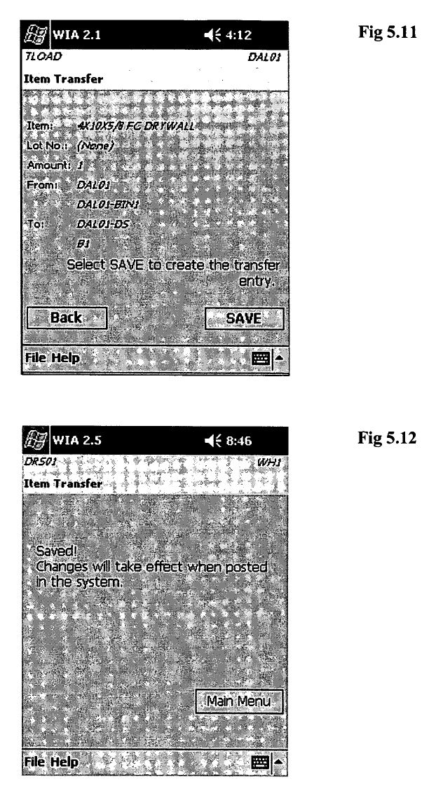

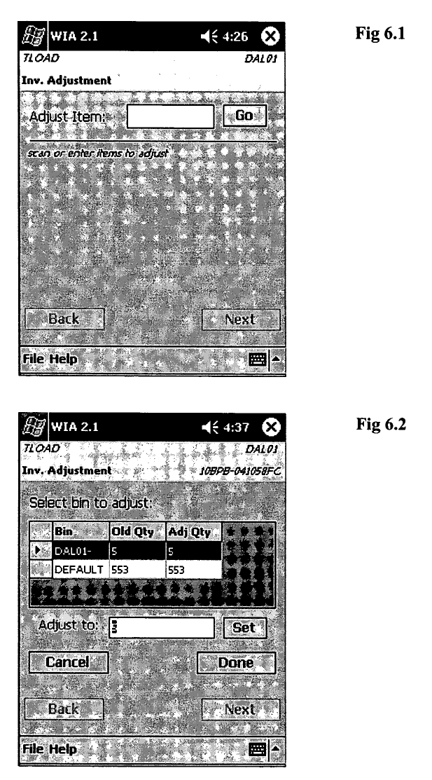

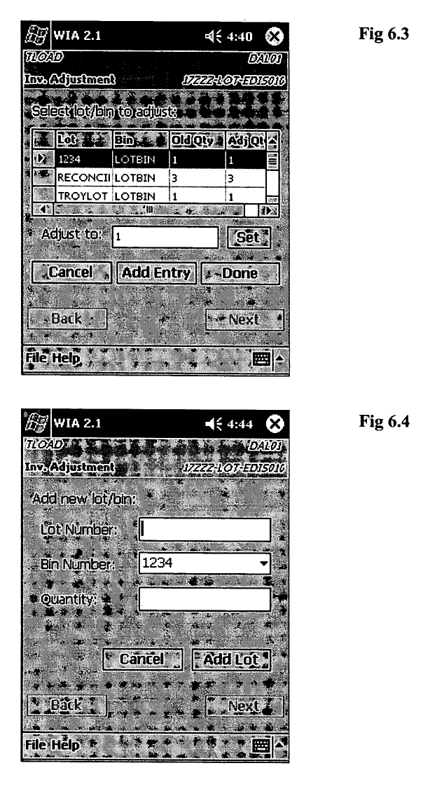

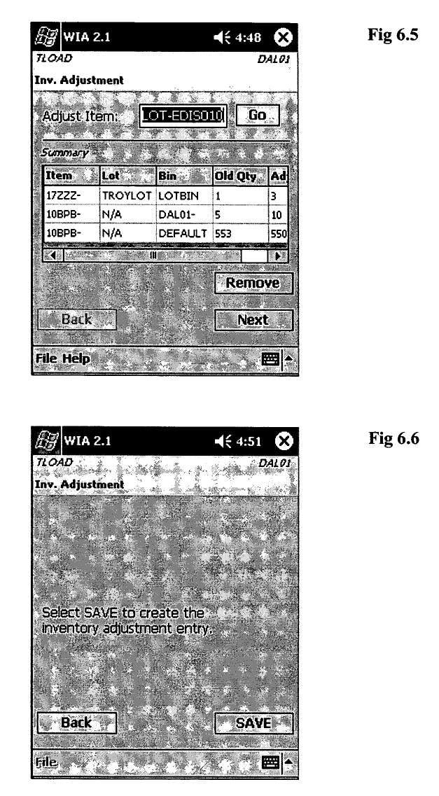

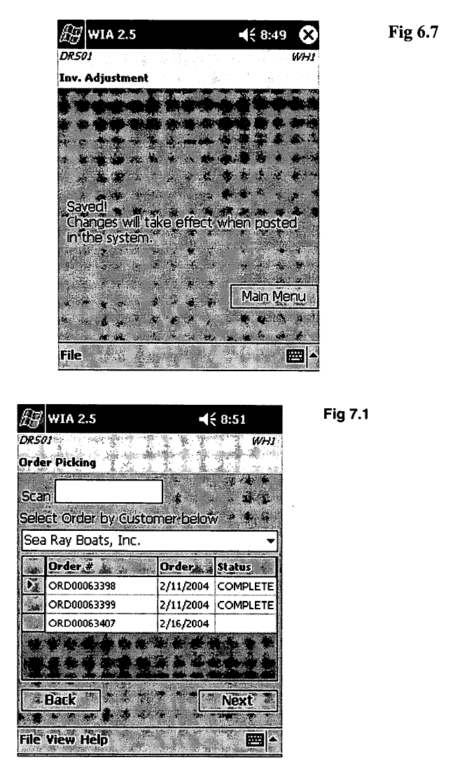

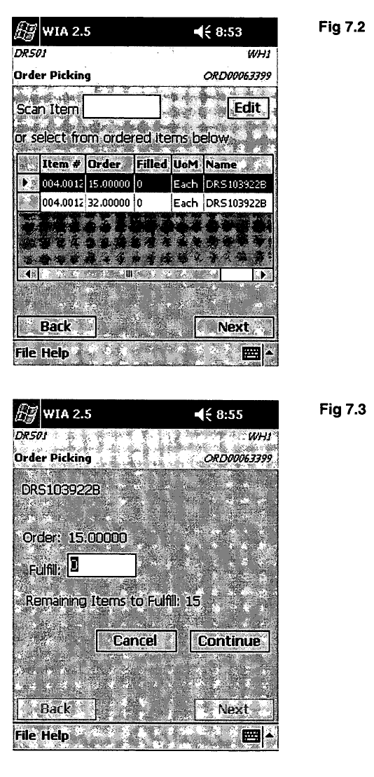

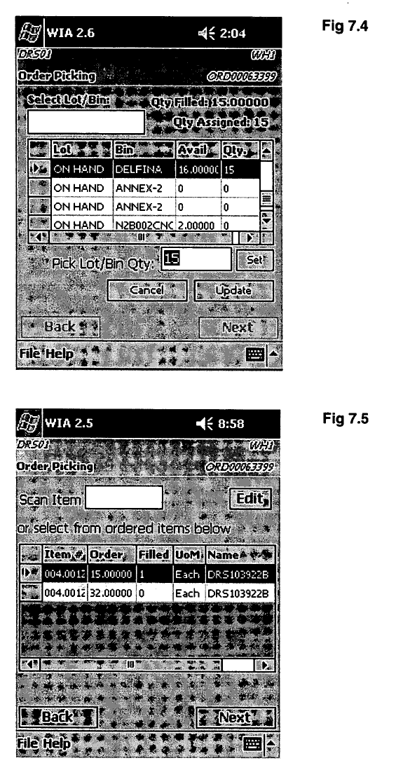

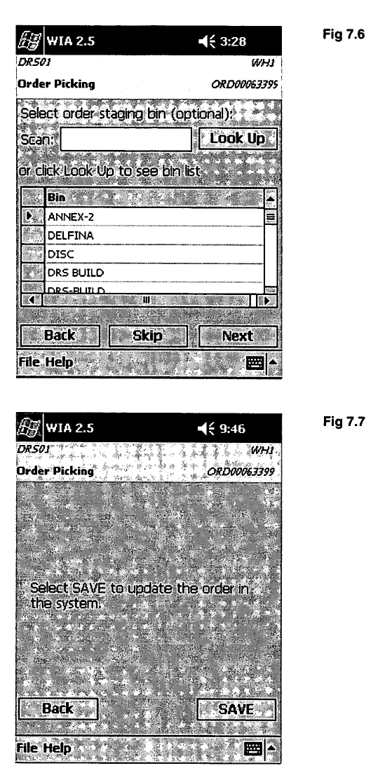

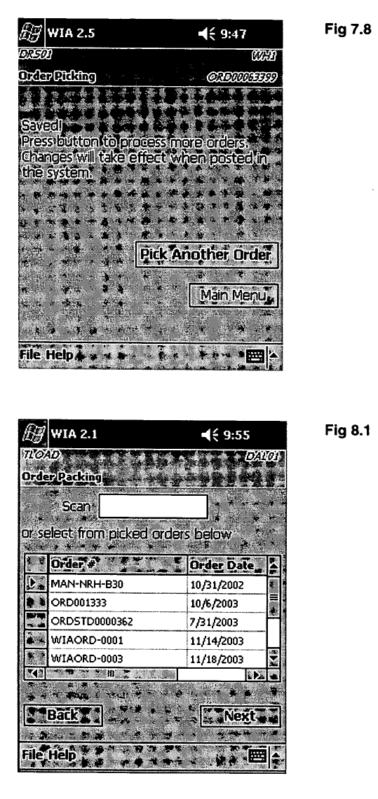

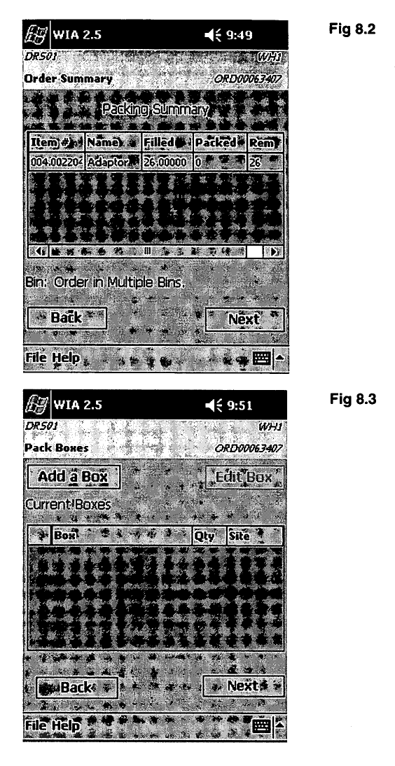

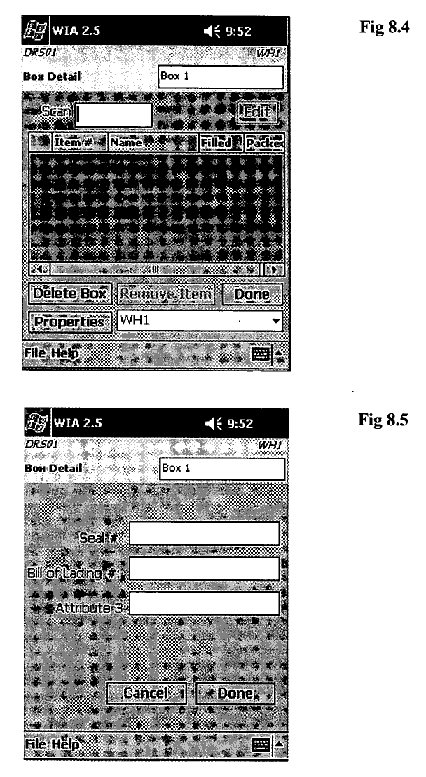

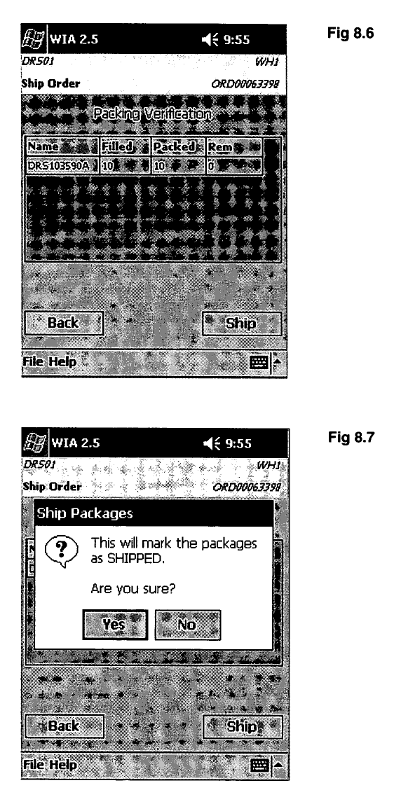

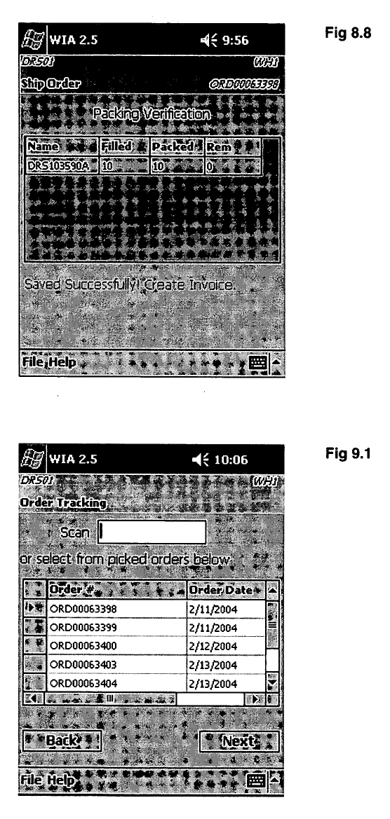

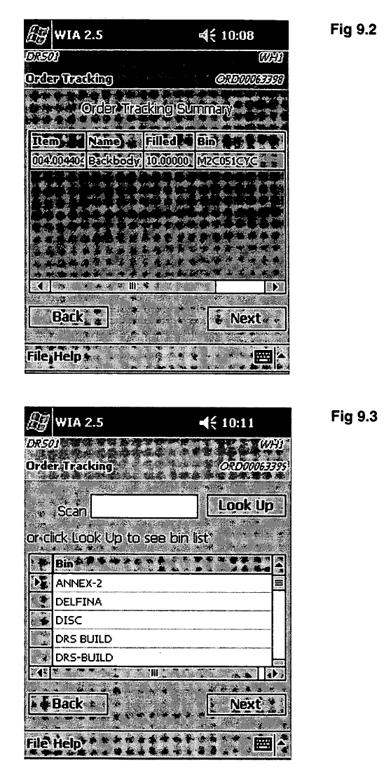

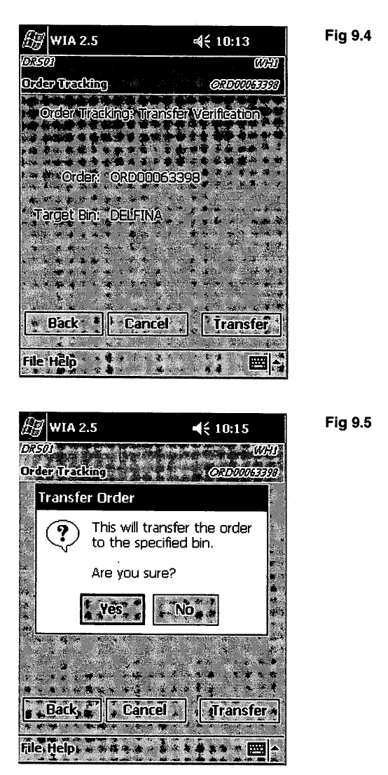

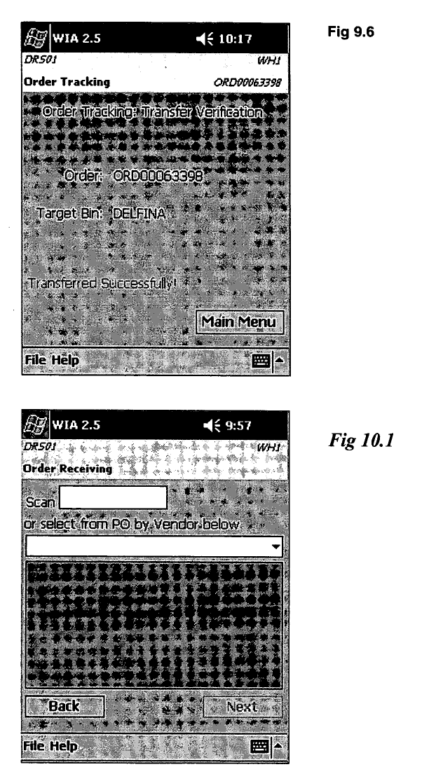

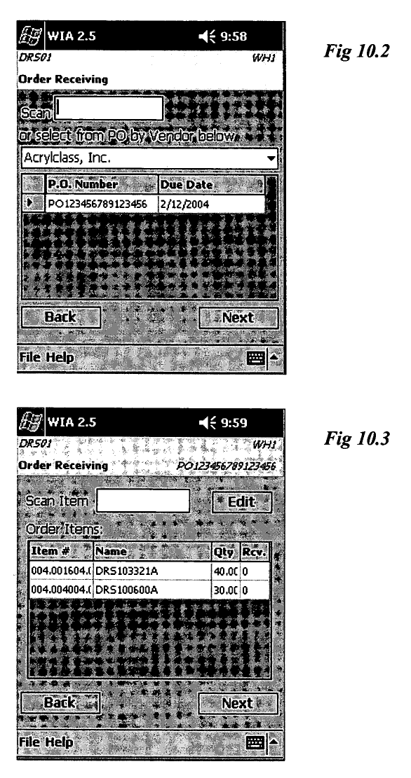

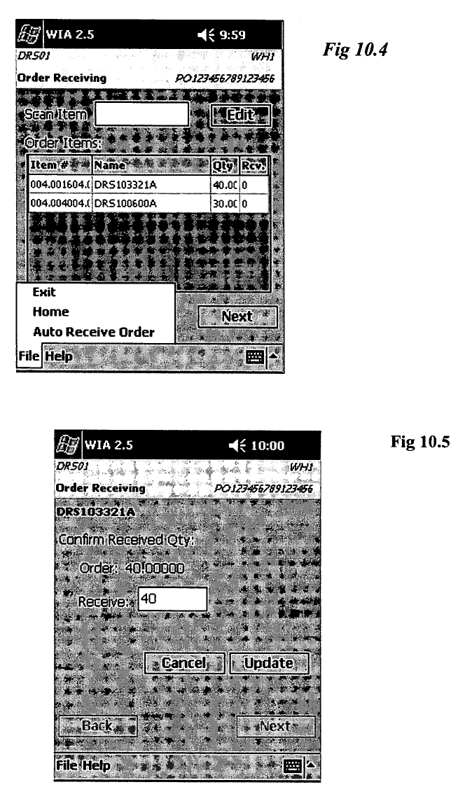

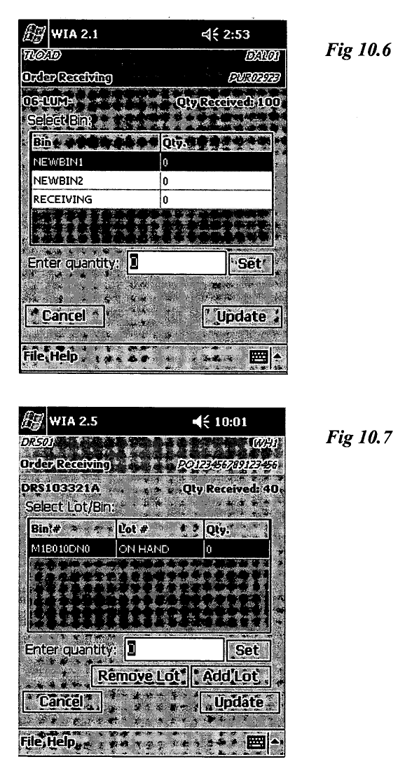

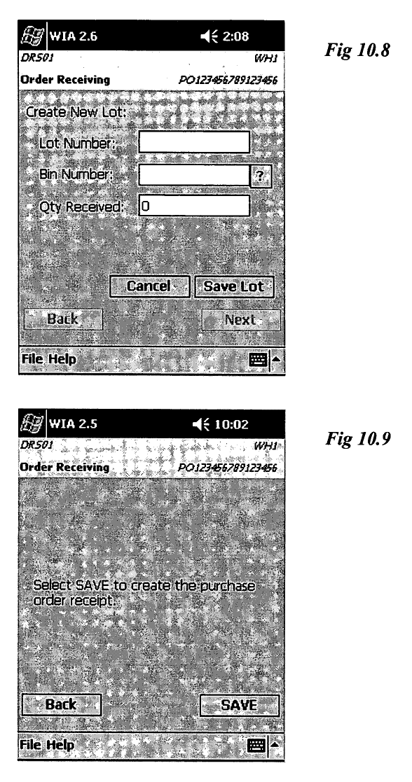

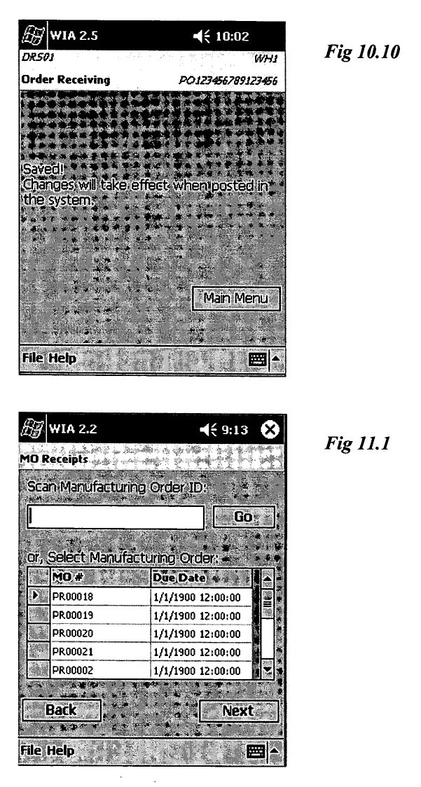

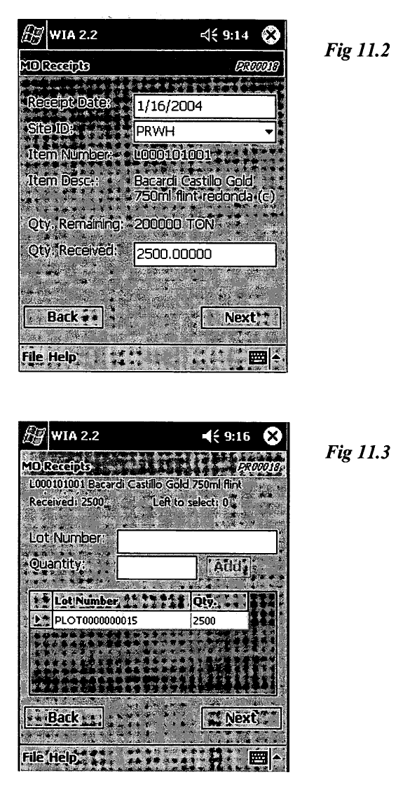

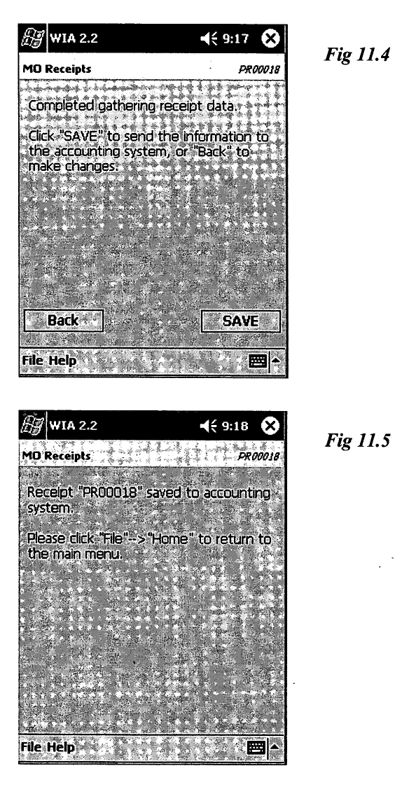

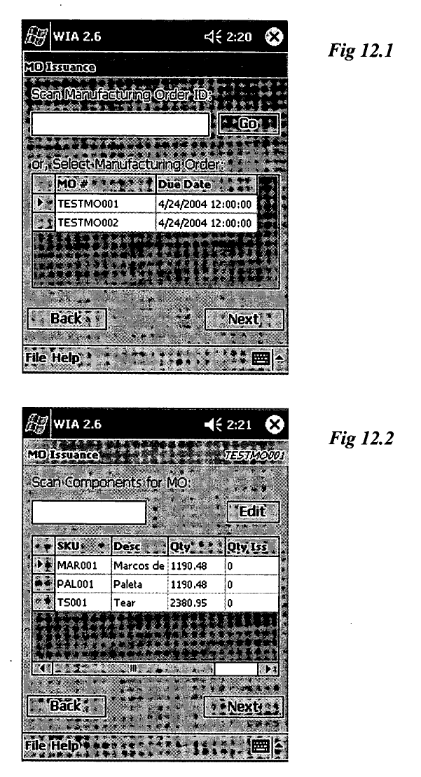

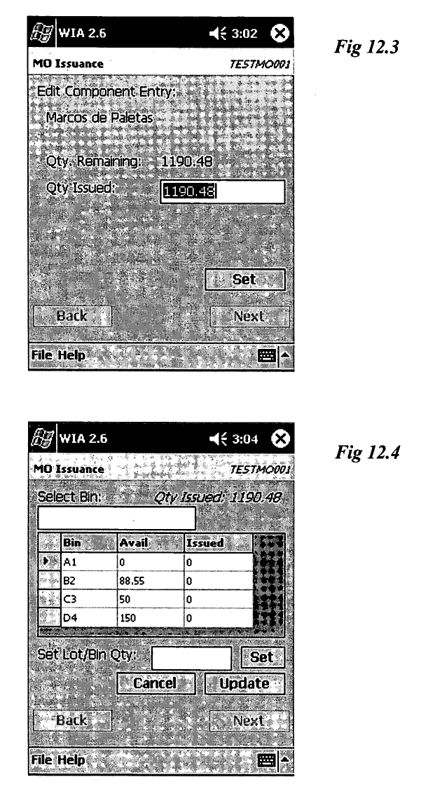

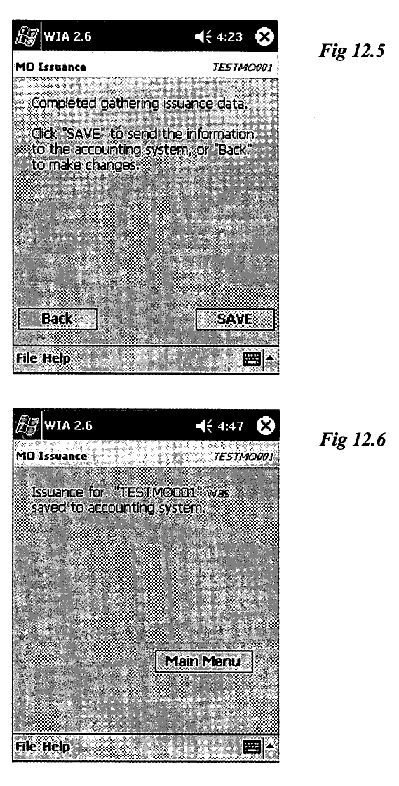

In order to work with the Wireless Inventory Application (WIA), the user must log into the application using a software authentication mechanism. FIG. 1.1 shows how a user enters their logon credentials and is authenticated by the application. In one embodiment, WIA uses the GREAT PLAINS software application (Microsoft, Redmond Wash.) including a SQL user ID and password. In order to log on to WIA, the user must supply the following information: database, user name, and password. As for the database, it is the server name and/or SQL instance name. This can be the IP address of the SQL Server, where GREAT PLAINS data is stored or the server's name. The format is “servername\instance” or “serveripaddress\instance.” If SQL is not installed using separate instances, then the \instance is not used.

After selecting a GREAT PLAINS database, a company select screen will supply a list of all locations defined within the company. This page allows a user to select a company database with which to work. In one embodiment, a drop-down list is populated with a list of company databases as defined in a “DYNAMICS” database in Great Plains. This is the same list of databases that is available when logging into the GREAT PLAINS desktop application. To select a company, pick the company name from the drop-down list.

This session information is stored by the system and used to connect the user to the selected company database until the user logs out of the current session.

The user must then select the location from a drop-down list. In one embodiment, a user selects the location from “Warehouse” (GREAT PLAINS Inventory Site Location) and clicks the “OK” button next to the location drop-down list to complete the login process. This login information is stored by the system and used to authenticate the user to the database until the user logs out of the current. The Warehouse is simply the inventory site that a user is working at or working with at this time. The Warehouse that is selected on this menu will be the default warehouse that populates the transactions. However, the user is able to change warehouses (GREAT PLAINS Inventory Sites) at the transaction level when fulfilling a sales order or receiving a purchase order.

With reference to FIG. 2.1, this page allows the user to select one of the WIA modules to work with. In one embodiment, the menu is divided into 3 logical areas as shown by the pop-up tabbed menu at the bottom of FIG. 2.1: Inventory Utilities (“Inventory”), Order Utilities (“Orders”) and Manufacturing Utilities (“Manufacturing”). Each utility group can be access by selecting “File” (Inventory or Orders or Manufacturing) at the bottom of the form or page. The system defaults to the Inventory utility group.

The following functions comprise the WIA Inventory Utilities of the application: Inventory Information, Inventory Count, Inventory Transfer, and Inventory Adjustment. These functions are shown in FIG. 2.1A. Inventory Information allows users to view item details, inventory quantities, and inventory tracking information about an item based on the item's UPC or SKU number. No information can be updated from this inquiry window. The Inventory Count function allows a user to upload physical transaction counts to a GREAT PLAINS Inventory Stock Count Entry. Before this information is uploaded, a Stock Count must be created in Great Plains. The Inventory Transfer function allows the user to relocate an item from one bin to another within the current site, or to transfer items from one site to another within the company. The Inventory Adjustment function allows the user to add an inventory adjustment entry to a batch in Great Plains.

FIG. 2.1B shows available WIA Order Utilities. With reference to FIG. 2.1B, Order Utilities comprise: Order Receiving, Order Picking, Order Packing, and Order Tracking. The Order Receiving application is used to create purchase order receipts. The process creates a purchase order receipt in Great Plains. A purchase order receipt may be created by using the drop-down menus: Transactions>Purchasing>Purchasing Batches>Receivings Transaction Entry. The Order Picking application is used for picking inventory in GREAT PLAINS Sales Order Fulfillment. In order for the Order to be displayed, the Inventory must be available and allocated to the Order. The Order Packing application allows a user to pack the order being fulfilled into separate packages prior to shipment. This information is not stored in Great Plains. The Order Tracking application allows a user to see where a picked order is located, and also to transfer a picked order from one location to another.

FIG. 2.1C shows WIA Manufacturing Utilities. With reference to FIG. 2.1C, these utilities comprise: Manufacturing Order Receipt, and Manufacturing Order Issuance. The Manufacturing Order Receipt application allows a user to receive a specific amount of items included in a Manufacturing Order. The Manufacturing Order application allows a user to create an issuance for a specific amount of raw materials for a manufacturing order.

In one embodiment, there is an Options menu. One function under Options is Change Default Site. The Change Default Site function allows a user to work within the context of the selected warehouse. All orders, items and other transactions are performed in the currently selected or logged-in warehouse. However, a user can use the Options menu to change the default logged in warehouse or site without logging out of the application.

FIG. 3.1 shows one embodiment of an Inventory Information utility. With reference to FIG. 3.1, this utility allows a user to scan an item with a handheld scanner and retrieve information about that particular item. After selecting “Inventory Information” from the Utilities menu, the user is taken to a screen such as the one shown in FIG. 3.1. From this screen or page, a user can either scan an item's barcode directly using a handheld scanner, or manually enter an item's bar code number in the blank space provided. After the barcode information is in the window, the scanner should auto-enter the information if the scanner supports the auto-enter function from scanning. If not, a user can select the enter key or tap the “Go” button to proceed.

FIG. 3.2 shows a “Scan Item Details” screen. With reference to FIG. 3.2, if an item is found within the system (database), information such as that shown is displayed. The details of an item is comprised of: SKU number, UPC number, item number, item name, a short description, and a default sales unit of measure. A user also is able to view at least the following details about the quantity of the item currently in inventory: quantity on hand (in the current GREAT PLAINS site), quantity allocated (for sales orders already entered or unposted transfers and/or inventory transactions), quantity available (to sell, transfer or transact), quantity on order (in GREAT PLAINS purchase orders), and quantity on back order (from GREAT PLAINS sales order not yet ordered).

By tapping the “View site information” button, a user is taken to a form, screen, or page that will display additional information about the item's on-hand availability in inventory. FIG. 3.3 shows one embodiment of such a form, screen, or page. With reference to FIG. 3.3, from this screen a user can select a site in the company to view. When the user has selected a site, the application displays a list of bins (and lot numbers if lot tracking is enabled for the selected item) along with the current quantity of the item in that site's inventory. The user can then tap a “Back” button of other software feature to return to the previous screen such as the one shown in FIG. 3.2 to scan another item.

With reference to FIG. 2.1A, the Inventory Count utility allows a user to update an active scheduled count within Great Plains. After selecting an “Inventory Count” button from the main menu, the user is presented with a list of active schedules in the database. FIG. 4.1 shows one embodiment of an Inventory Count utility window which displays a listing of all Stock Counts that have been started using GREAT PLAINS Inventory Stock Count. One way to access or start the count is to select: Transactions>Inventory>Stock Count Schedule>Start Count from the pull-down menus. The stock count must be started before a user is allowed to enter count information. With reference to FIG. 4.1, this list contains the name of the scheduled count, the last time the count was updated, and the total number of items to be counted. To select a scheduled count to work with, tap on the count name to select it and then tap the “Next” button. To return to the previous page, tap the “Back” button.

With reference to FIG. 4.2, a user is then taken to a screen that displays all of the bins that are included in the stock count. The user should select a bin to work with by scanning the bin number or selecting the bin from the grid and tapping the “Next” button.

With reference to FIG. 4.3, after a user has selected a bin to work with, the user is taken to a screen that displays the items in the bin that need to be counted. The user can select an item to count by scanning it or by manually typing the item's SKU in the text box and pressing the “Enter” key on the soft keyboard. If the item is included in the stock count for the current bin, scanning it will increment the “Qty” field in the grid by one. If the scanned item is not recognized as belonging to the current bin in the stock count, the screen displays an error message stating the item cannot be included in the count. A user can also manually adjust the quantity of an item or enter lot numbers for lot tracking items by selecting the item from the list and clicking the “Edit” button.

With reference to FIG. 4.4, when a user selects an item and taps the “Edit” key, the user is taken to a screen where the counted quantity of the current item can be manually adjusted. Also, the user can select a verify (“verified”) checkbox to indicate that the counted quantity has been verified in the GREAT PLAINS inventory count. The user can tap the “Update” button to accept the changes and continue, or “Cancel” to return to the previous screen. Tapping the “Update” button saves the adjusted quantity and verified information for the selected item. Then, if lot tracking has not been enabled for the current item, the user will be returned to the previous screen

With reference to FIG. 4.5, if the selected item has lot tracking enabled, then clicking “Update” will take the user to a screen where the counted items can have their lot numbers recorded. To indicate an item's lot number, the user selects a lot number from the list, types in the quantity of the items counted that belong to the current lot number, and taps the “Set” button to update the quantity for that lot number. If the item scanned belongs to a lot number that is not in the list in inventory, the user can add a new lot number by tapping the “Add Lot” button.

When all items have had their lot numbers indicated, the user can tap the “Update” button to select another item from the bin to count. The user can also tap the “Cancel” button to discard changes to the recorded lot numbers for the item. Tapping “Cancel” from this screen does not cause the counted quantity value saved on the previous screen to be discarded.

With reference to FIG. 4.6, if a user taps the “Add Lot” button from the Lot Number screen shown in FIG. 4.5, the user is taken to a screen where a new lot number can be added to inventory for the current item. The user can enter the new lot number and the quantity of the lot number in the current bin, and tap the “Save Lot” button to add the new entry to the lot number list. After the user has finished counting items in the current bin, the user can tap the “Next” button (see FIG. 4.3) to save the bin count to the accounting system. Note, a user cannot save count information unless all items with lot tracking enabled have had their lot numbers recorded in the application.

With reference to FIG. 4.7, when a user has tapped the “Next” button to continue saving the item count, the application displays a confirmation message to verify that a user is ready to save the information to the accounting system. The user can click the “Save” button to save the bin count information, or “Back” to return to the data entry interface.

With reference to FIG. 4.8, once a user has chosen to save the bin count to the accounting system, the application displays a message indicating that the count has been updated. The user can then use the “Continue” button to continue working with the current inventory count. To return to the main menu, a user can tap the “Main Menu” button or use the menu system. In one embodiment, this can be accomplished by selecting File>Home.

With reference to FIG. 2.1A, the next utility is Inventory Transfer. This utility allows the user to transfer items in inventory between bins within the same site in the accounting system, or between different sites in the company. After selecting “Inventory Transfer” from the application's main menu, the user is taken to a screen such as the one shown in FIG. 5.1. With reference to FIG. 5.1, from this screen, a user can select which type of item transfer to perform. A “Bin to Bin” transfer is used to transfer items to different bins within the user's current site. A “Site to Site” transfer is used to transfer items from one site within a company to another site. Note, another significant difference between “Bin to Bin” and “Site to Site” transfers is that a bin-to-bin transfer immediately updates the bin quantities in the accounting system while a site-to-site transfer creates an inventory transfer entry in the accounting system that must be manually posted at a later time. From this screen, the user can select the type of transfer that is needed by tapping the appropriate button. If a bin-to-bin transfer is selected, the user is taken to a screen to scan the item to be transferred or the lot number for an item to be transferred. After the item is scanned, the user taps the “GO” button to retrieve details about the item.

With reference to FIG. 5.2, from this screen a user is able to enter the quantity being transferred. If the item has enough on-hand quantity in inventory, then the user is able to click the “Next” button to select the bin to transfer the item out of.

With reference to FIG. 5.3, from this screen the user can select a bin to transfer the item from by tapping the name of a bin from the list of bins in the system where the item is currently located. After the user has selected a source bin, the user taps the “Next” button to continue with setting up the item transfer. Items with lot tracking enabled have a list of bins with lot numbers for the user to select.

With reference to FIG. 5.4, from this screen a user can scan the bin number to transfer the items into. Alternatively, the user can tap the “Look Up” button to populate the bin lookup list with the bins defined in the current company, and can choose a transfer bin by selecting one from the list and tapping the “Next” button. Once the user has scanned or selected a destination bin, the user is taken to a transfer confirmation screen such as the one shown in FIG. 5.5.

With reference to FIG. 5.5, from this screen, a user can view a summary of the item transfer as it has been entered into the WIA system. If anything needs to be altered in the transfer, a user can use the “Back” button to navigate to an appropriate screen to make the changes. If the item transfer is correct, the user can select the “Save” button to save the transfer to Great Plains.

With reference to FIG. 5.6, if the item transfer was successfully saved, then the user will see a screen such as the one shown. From this screen the user can return to the application's start menu by tapping the “Main Menu” button or by selecting “File>Home” from the application menu at the bottom of the screen. If a site-to-site transfer is selected, the user is taken to a screen to select the source and destination sites for the item transfer.

With reference to FIG. 5.7, after the user has selected the source and destination sites for the transfer, the user taps the “Next” button to continue. The application takes the user to a screen where the user can scan the item to be transferred. After the user scans the item to be transferred, the user taps the “Go” button to retrieve information about the selected item and enter the quantity of the item to be transferred.

With reference to FIG. 5.8, once the user has selected the quantity of the item to transfer, the user taps the “Next” button to continue entering information about the transfer. The user is taken to a new screen to select the bin transfer items out of from the source site.

With reference to FIG. 5.9, a user can select a bin to transfer items from by selecting the target bin from the bin list and tapping the “Next” button to continue. The user is then taken to a screen to select the target bin in the destination site to transfer the items into.

With reference to FIG. 5.10, a user can select the bin to transfer the items into by tapping the bin name from the bin list and tapping the “Next” button to continue. The user is then taken to a summary screen to confirm the details of the item transfer.

With reference to FIG. 5.11, a user can review the details of the transfer and tap the “Save” button to create the transfer entry in the accounting system. With reference to FIG. 5.12, once the transfer entry has been created in the accounting system, the application displays a confirmation message to the user. The user can continue by tapping the “Main Menu” button or by selecting “File”>“Home” from the application menu to return to the applications start menu.

With reference to FIG. 2.1A, the Inventory Adjustments utility allows a user to create an adjustment entry to alter the on-hand quantity of items in inventory for the user's current site. After selecting “Inventory Adjustment” from the application's main menu, the user is taken to a screen such as the one shown in FIG. 6.1. With reference to FIG. 6.1, a user can either scan the item or manually type in the item's SKU. Once the user has selected an item to adjust, the user taps the “Go” key to continue creating the adjustment entry. If the item to be adjusted does not have inventory tracking enabled, the user is shown a grid that contains a list of the bins for which to adjust the item quantity. If the item to be transferred has lot tracking enabled, the list also indicates the item lot numbers present in each bin.

With reference to FIG. 6.2, a user can select the new quantity present in each bin for the item by selecting the bin from the bin list, typing the adjusted quantity in the text field, and tapping the “Set” button. Once the user has finished adjusting the item quantities, the user can tap the “Done” button to continue. If the item has lot tracking enabled, the user is able to select the item to adjust by the item's lot number and bin location.

With reference to FIG. 6.3, from this screen, the user can select the item quantity to adjust by lot number and bin location. To adjust the item quantity, a user selects the appropriate lot number and bin, types the new quantity in the text field, and taps the “Set” button to set the new quantity. If the item to be adjusted belongs to a lot that is not currently present in inventory, the user can tap the “Add Entry” button to add a new lot number to the list.

With reference to FIG. 6.4, a user can type in the new lot number, select the bin to place the item in, and select the quantity of the item to be added to the bin. The user can then tap the “Add Lot” button to add the lot to the current transfer entry and return to the previous screen. When the user has finished editing the bin quantities for the selected item, the user can tap the “Update” button to return to the first screen to see a summary of the current transfer entry.

With reference to FIG. 6.5, a user can scan another item to include in the transfer by entering the item SKU in the text field and tapping the “Go” button. The user can also remove an item from the transfer by selecting the item from the summary panel and tapping the “Remove” button. Once the user is satisfied with the contents of the adjustment entry, the user taps the “Next” button to save the adjustment entry to the accounting system. The user is taken to a screen to verify that the user is ready to save the adjustment entry.

With reference to FIG. 6.6, from this screen the user can tap the “Save” button to save the adjustment entry to a batch within the accounting system. With reference to FIG. 6.7, the user can return to the application main menu by tapping the “Main Menu” button or by selecting “File”>“Home” from the application menu at the bottom of the screen. WIA does not actually post the adjustment entry. The adjustment entry is added to a batch which must be posted manually from within Great Plains.

With reference to FIG. 2.1B, the Order Picking utility allows a user to pull a customer's order that exists in Great Plains. After selecting the Order Picking application from the main menu, the user is taken to a page where an order can be selected such as the page, form or window shown in FIG. 7.1. With reference to FIG. 7. 1, from this screen, the user can scan the order number from a barcode or manually type it into the textbox and tap the “Next” button to begin fulfilling an order in the application. If the user scans an order that is not available in the accounting system, the application will display an error message.

Alternatively, the user can also select a customer name from the drop-down list to view a list of all open orders. Orders that have already been completely filled and are ready for packaging are indicated as having a “Complete” status. The user can select an order from the list and tap the “Next” button to begin fulfilling that order. Orders with a “Complete” status (i.e. orders that have already been completely picked) can still be modified from this application.

After a user has selected an order to fulfill, a screen appears that allows a user to begin scanning the items for the order or to select an item from the list. With reference to FIG. 7.2, from this screen, a user can scan an item to increment the quantity filled value by one for each time the item is scanned. The user can also select an item and tap the “Edit” button to manually adjust the quantity received field and to record the lot number and bin locations of the items that have been pulled for this order. The application does not save order fulfillment information unless all items being pulled have had lot number and source bin information supplied by the user. When the user is ready to record the pulled items source bin and lot number information (if appropriate), the user can select an item from the item list and tap the “Edit” key at the top of the screen.

With reference to FIG. 7.3, when the user selects an item from the order item list and taps the “Edit” key, the user is taken to a screen where the filled quantity can be manually adjusted from the quantity that was scanned. Once the user is satisfied with the quantity filled value, the user can tap the “Continue” button to save the filled quantity to the application and continue to the source bin selection screen.

With reference to FIG. 7.4, when a user taps the “Continue” button from the item fulfillment screen, the user is taken to a screen listing all the bins that the item is found in. If the item has lot tracking enabled, the list contains all the lot numbers for that item currently in inventory, along with the bin numbers where each lot item is found in inventory. The user can record which lots and bins the items pulled for the current order came from by selecting the lot/bin from the list, typing the quantity in the text field, and tapping the “Set” button.

The user can also scan or type in the lot number, in which case the system selects the first found entry in the lot list that matches the entry, and set the Qty amount (filled quantity) to the “Avail” amount (available item count in the lot). This allows the users to pick the complete lot into the order. The user can still modify the quantity filled if necessary. Once the user has recorded the bin information for the current item, the user can click on the “Update” button to save the information to the application and return to the scan item screen.

With reference to FIG. 7.5, a user can continue to scan line items repeating the process of fulfilling the line orders or select Next to update the order in Great Plains. After all items are fulfilled, a user clicks on the “Next” button.

With reference to FIG. 7.6, a user is then taken to a screen where the order can optionally be transferred to a holding bin to await packaging. The user can either scan the bin name to transfer the picked items to, or the user can tap the “Look Up” button to select the bin from the list box. This step is optional; the user can choose to tap the “Skip” button to continue without transferring the picked items to a holding bin, or the user can tap the “Next” button to select the transfer location. The skip button only appears if the application is setup to have this step optional. In one embodiment, this option is configured using a file, such as but not limited to, an XML file named “config.xml.”

With reference to FIG. 7.7, a user now has the option to go back into the order and review the fulfilled lines one last time or click on “SAVE” to save the information into the GREAT PLAINS Database. A user taps the save button to get to the confirmation window.

With reference to FIG. 7.8, when a user selects the “Save” button, the order fulfillment information is sent to the accounting system. The application then displays a message to the user confirming that the information was successfully entered into the system. To continue filling orders, a user taps a “Pick Another Order” button. To return to the main menu, a user taps the “Main Menu” button or selects “File>Home” from the menu system. Saving order fulfillment information to GREAT PLAINS does not immediately update inventory information in the system. The order must be manually transferred to invoice from within the GREAT PLAINS application.

With reference to FIG. 2.1B, an Order Packing application allows a user to organize a customer's order by boxes and create packing slips for each box. After a user selects the Order Packing module from the Application Main Menu, the user is allowed to scan an order ID from the barcode on the orders picking ticket.

With reference to FIG. 8.1, from this page a user can select an order to work with by scanning (or manually entering) the order ID and tapping the “Next” button. To return to the main menu, the user can tap the “Back” button. After selecting an order to work with, the system takes the user to a Packing Summary screen, such as the one shown in FIG. 8.2, that displays all the items on the order and the quantities that are filled and ready to pack, along with the bin in which the item is currently located (or a notice if the order is currently located in more than one bin). The user clicks “Next” to get to an Add a Box page such as the one shown in FIG. 8.3. With reference to FIG. 8.3, a user must add a new box from this menu by clicking on the “Add a Box” button. This will add a new package to the order and take the user to the Box Contents screen such as the one shown in FIG. 8.4.

With reference to FIG. 8.4, from this screen a user can change the default name for the box by typing a new box name in the text field at the top of the screen (across the screen from the “Box Detail” label or field). The user can also begin scanning items from an order to package inside the box. Once the user has finished packing the box and is satisfied with the box contents, the user can tap the “Done” button to save the box name and contents to the application. The user can also remove the box information from the application by tapping the “Delete Box” button. Clicking this button returns the user to the Pack Boxes summary page. The user can supply additional information about the boxes by tapping the “Properties” button. Tapping this button takes the user to the Box Properties page such as the one shown in FIG. 8.5.

With reference to FIG. 8.5, from this screen, a user can add information about three user-defined attributes of the package. When the user has finished adding attribute information to the package, the user can click “Done” to save the attributes to the application, or “Cancel” to return to the previous screen without saving changes to the package attributes. When the user has finished packaging items for the order, the user can click the “Next” button from the Pack Boxes screen. The application will then display a summary of the items that have been packed such as on the summary or packaging verification screen shown in FIG. 8.6.

With reference to FIG. 8.6, the user can review the packaging details from this screen. If a user needs to make any further changes, the user can tap the “Back” button to return to the Pack Items screen. When the shipment is ready to be put on the delivery mechanism (Truck, Ship etc.) the user can click on the “Ship” Button.

With reference to FIG. 8.7, a user must confirm that the user is sure about shipping the package. Confirming the shipment in this way updates the “Date Shipped” field in the order and allows the user to transfer the order to invoice. If the user chooses to mark the packages as “Shipped”, the application updates the Date Shipped field in the accounting system for the order items that have been packaged. The application then displays a confirmation message to the user that the package has been marked as shipped such as on the screen shown in FIG. 8.8. After the package has been marked as shipped, the user can use the application menu (“File”>“Home”) to return to the main menu.

With reference to FIG. 2.1B, the Order Tracking function allows a user to quickly view the current location of a picked order within the warehouse, and to transfer that order to another bin if needed. With reference to FIG. 9.1, after a user selects “Order Tracking” from the main menu, the user is taken to a screen where the order ID can either be scanned into the application or selected from a list box containing all the orders in the system that have been picked. Once the user has selected an order to track, the user can tap the “Next” button to continue.

With reference to FIG. 9.2, from this screen a user can see the items in the selected order, the quantity filled for each item, and each items current location (bin) in the warehouse. From here, the user can select “Back” to check the location of a different order, or use the menu at the bottom of the screen to return to the main menu (“File>Home”). If the user wishes to transfer the current item to a different bin in the warehouse, the user can tap the “Next” button to continue.

With reference to FIG. 9.3, from this screen, a user can scan the destination bin number into the application. Alternatively, the user can tap the “Look Up” button to retrieve a list of bins from the current warehouse. After the user has selected a destination bin, the user can tap the “Next” button to continue, or “Back” to return to the order tracking summary page.

With reference to FIG. 9.4, the user is then taken to a confirmation screen, showing the name of the picked order that is being transferred, and the bin the order contents are being transferred into. From this screen, the user can tap the “Back” button to return to the target bin selection screen, “Cancel” to return to the main menu without transferring the order, or “Transfer” to transfer the order contents to the target bin.

With reference to FIG. 9.5, if the user taps the “Transfer” button, the system queries the user to confirm that the current order's contents are to be transferred to the target bin. The user can tap a “No” button to return to the previous screen without transferring the order, or a “Yes” button to confirm the order transfer.

With reference to FIG. 9.6, if the user confirms that the order is to be transferred, the application transfers the order to the target bin in the warehouse and displays a confirmation message to the user. The user can then return to the main menu by either tapping the “Main Menu” button or using the menu (“File”>“Home”) at the bottom of the screen.

With reference to FIG. 2.1B, the Order Receiving function allows a user to receive purchase orders from suppliers. After the user selects the Order Receiving function from the application's main menu, the user is allowed to scan a purchase order ID from the barcode on the purchase order ticket. The user can also select a vendor from the drop down list to narrow the list of Purchase order numbers being retrieved to the WIA system. A user clicks on the drop down list and selects the vendor that has made the received shipment.

With reference to FIG. 10.1, once a vendor has been selected, the screen will look like the one in FIG. 10.2. With reference to FIG. 10.2, to select a purchase order, the user can scan or manually enter the order ID into the space provided and click the “Next” button to proceed. The user can also click the “Back” button to return to the previous page or the logo at the top of the screen to return to the main menu. The user clicks on the purchase order and selects a “Next” Button to advance to the following screen such as the one shown in FIG. 10.3.

With reference to FIG. 10.3, from this screen the user can either scan an item or manually select an item from the table to begin the count for that item. Scanning an item or pressing the enter key on the keyboard automatically increments that item'.s count; manually selecting an item from the list will not increment the item count. Alternatively, the user can select “Auto Receive Order” from the menu at the bottom of the screen; this selection is shown in FIG. 10.4. Selecting this link sets the received count for each item in the purchase order to the ordered amount and continues to the next page. After an item is auto-received, the user must still go through each item and assign the bins into which to receive the items, and to specify the items lot number if appropriate. The application cannot save the purchase order receipt until this information has been supplied by the user.

To manually adjust the quantity received and to select the bin and lot number (if applicable) for an item being received, a user must select an item from the list and tap the “Edit” button. An edit screen is shown in FIG. 10.5. With reference to FIG. 10.5, a user enters the quantity being received and clicks the Update button. The user then is taken to a screen where, depending on the selected item's tracking type, the user can select the bin into which the item is to be received, or the item's receiving bin and lot number. If the item being received does not have lot number tracking enabled, the user is taken to the screen shown in FIG. 10.6.

With reference to FIG. 10.6, from this screen the user can select the bins to receive the item into. The user can split the quantity received among any number of bins. However, the user must specify a receiving bin location for all items received. Once the user has finished assigning the items received into warehouse bins, the user can tap the “Update” button to save the assignment information into the WIA system and to return to the scan item screen. If the item being received has lot number tracking enabled, the user is taken to the screen shown in FIG. 10.7 instead.

With reference to FIG. 10.7, from this screen the user can select the lot number the received items belong to, and the bins the items are received into. The user can split the quantity received among any number of lot numbers and any number of bins. However, the user must specify lot numbers and receiving bin locations for all items received. If the items being received belong to a lot number that does not already exist in the system, the user can tap the “Add Lot” button to create a new lot number entry in the list.

With reference to FIG. 10.8, from this screen, the user can type or scan the new lot number being received, the bin it is being received into, and the quantity of the item being received. The user can then tap the “Save Lot” button to return to the previous screen, which will be updated to include the new lot number\bin entry. Tapping the “?” button next to the bin number field replaces the text box with a drop-down box containing a list of all bins in the system. The user can also use this drop-down box to select the bin. Once the user has finished specifying the lot numbers and warehouse bins for the items received, the user can tap the “Update” button to save the assignment information to WIA and return to the scan item screen. Once the user is finished counting the items in the purchase order, the user can either select the “Next” button to continue, or the “Back” button to return to the previous page. The user can also return to the Application Main Menu without saving the purchase order count File>Home.

With reference to FIG. 10.9, a user is taken to the Order Receiving Confirmation screen. The user can then go back and continue receiving line items or correct information by tapping the “Back” button, or save the new purchase order receipt in the accounting system by tapping the “Save” button. With reference to FIG. 10.10, once the user has tapped the “Save” button, the application creates the new purchase order receipt in the accounting system, and displays a confirmation message to the user. The user can then return to the main menu by tapping the “Main Menu” button or by using the application menu (“File”, “Home”) at the bottom of the screen.

With reference to FIG. 2.1C, a Manufacturing Order Receiving function allows a user to create receipts for Manufacturing Orders. After the user selects the Manufacturing Order Receipt function from the main menu, the user is allowed to scan a manufacturing order ID from the barcode on the manufacturing order ticket. The user can also select the manufacturing order from the grid listing all manufacturing orders.

With reference to FIG. 11.1, once the manufacturing order has been selected, the screen appears as shown in FIG. 11.2. The user can now specify the order receipt date, the warehouse and the quantity to receive. The receipt quantity defaults to the “Minimum Shipment Amount” as specified in the Manufacturing Order in Great Plains. However, the user can change this quantity if necessary. After making necessary changes to the order, the user can click the “Next” button to proceed to the next screen such as the one shown in FIG. 11.3. The user can also click the “Back” button to return to the previous page.

With reference to FIG. 11.3, this screen allows the user to specify the lot numbers and associated quantities for the amount of item being received. This screen allows certain functionality depending on the settings specified for the application instance. These settings are may be set in a file. In one embodiment, these settings are included in an XML file such as in a config.xml. By default, the system allows the user to specify a breakdown of the total receipt amount into multiple lots as identified by the user. However, if the configuration is set to “autocreate”, then the system automatically creates a lot number based on specifications in the WIA database tables, and assigns the total receipt amount to this lot, hence the system does not allow a breakdown of quantities into multiple lots and does not allow the user to change the lot number. The textboxes (Lot Number and Quantity) and the “Add” button are disabled in this instance. The user can note the details presented in this page if necessary (or if applicable provide the lot and quantity assignments), and press next to continue to the next page such as the one shown in FIG. 11.4.

With reference to FIG. 11.4, the user is taken to a Manufacturing Order Receiving Confirmation screen. The user can then go back and continue receiving items or correct information by tapping the “Back” button, or save the new manufacturing order receipt in the accounting system by tapping the “Save” button. Once the user has tapped the “Save” button, the application creates the new manufacturing order receipt in the accounting system, and displays a confirmation message to the user such as the one shown in FIG. 11.5. The user can then return to the main menu by using the application menu (“File”, “Home”) at the bottom of the screen. Throughout this process, there is a requirement for this module on the server that a GREAT PLAINS instance must be running and logged in on the physical web server.

With reference to FIG. 2.1C, a Manufacturing Order Issuance function allows a user to issue raw materials for a manufacturing order. With reference to FIG. 12.1, after the user selects the Manufacturing Order Issuance function from the main menu, a new screen allows the user to scan a manufacturing order ID from the barcode on the manufacturing order ticket. The user can also select the manufacturing order from the grid listing all manufacturing orders.

Once the manufacturing order has been selected, the screen looks as shown in FIG. 12.2. With reference to FIG. 12.2, a user can scan or type the SKU and press enter to increment the quantity issued for an item in the issuance. To manually adjust the quantity issued and the item's lot\bin source, the user can select the item from the table and click the “Edit” button; the user is then taken to a screen like the one shown in FIG. 12.3.

With reference to FIG. 12.3, from this screen the user can manually adjust the selected item's quantity issued by typing in a new quantity and tapping the “Set” button to continue to a new screen such as the one shown in FIG. 12.4.

With reference to FIG. 12.4, from this screen, the user can scan or type in a bin or lot number to increment the amount of the quantity issued from each lot\bin. When the qty issued has been completely assigned to lots or bins, the user can select “Update” to save the assignments and continue working with the issuance. Once the user has finished issuing materials to the manufacturing order, the user can click the “Next” button to continue with saving the issuance to the accounting system.

With reference to FIG. 12.5, from this screen, the user can tap the save button to save the materials issuance to the accounting system, or the back button to return to working with the issuance. Tapping “Save” takes the information and saves it to the accounting system. The materials issuance in this instance is saved to the accounting system. However, it must still be posted through Great Plains. When the issuance is successfully saved, the user is taken to a confirmation screen such as the one shown in FIG. 12.6. The user can then return to the main menu by using the application menu (“File”, “Home”) at the bottom of the screen.

The foregoing discussion of the invention has been presented for purposes of illustration and description. Further, the description is not intended to limit the invention to the form disclosed herein. Consequently, variation and modification commensurate with the above teachings, within the skill and knowledge of the relevant art, are within the scope of the present invention. The embodiment described herein and above is further intended to explain the best mode presently known of practicing the invention and to enable others skilled in the art to utilize the invention as such, or in other embodiments, and with the various modifications required by their particular application or uses of the invention. It is intended that the appended claims be construed to include alternate embodiments to the extent permitted.

I claim:

1. A method for updating inventory information in an accounting system comprising the steps of:
a. scanning information from a product label using a wireless handheld device;
b. passing the scanned information to a relational database;
c. passing the information from the relational database to the accounting system; and,
d. displaying the information on a computer screen.
